(19) United States
(12) Patent Application Publication
(10) Pub. No.: US 2026/0138014 A1
(43) Pub. Date: May 21, 2026

(54) Delivery of Alternate Content During Video Game Wait Times

(71) Applicant: Sony Interactive Entertainment Inc., Tokyo (JP)

(72) Inventor: Sean Whitcomb, Issaquah, WA (US)

(73) Assignee: Sony Interactive Entertainment Inc., Tokyo (JP)

(21) Appl. No.: 18/949,581

(22) Filed: Nov. 15, 2024

(51) Int. Cl. A63F 13/48; A63F 13/61; A63F 13/67; A63F 13/798

(52) U.S. Cl. CPC A63F 13/48; A63F 13/67; A63F 13/798; A63F 13/61

(57) ABSTRACT

A gaming console and method of operating a gaming console for delivering alternate content during appropriate times are provided. During gameplay, graphical game images can be provided on a screen. It can be determined that an appropriate time for alternate content is beginning. The appropriate time can be a time before a commencement of a new game. Prior to the commencement of the new game, informational images can be provided to the screen. The informational images can indicate a list of players of the new game. Information can be retrieved regarding one or more of the indicated players in the list of players. The alternate content can be provided, which can include a report about the information retrieved regarding one or more of the indicated players in the list of players.

### BACKGROUND

Video games can be an incredibly immersive form of entertainment. Whether played alone or in groups over the internet, video games can be challenging and engaging. But on occasion, the action can stop of necessity while graphics are loaded, new players are added, and other similar reasons. This stoppage can be jarring and discontinuous with the high level of interaction that occurs during a game. Thus what is needed are methods, systems, and code that can reduce this discontinuity in level of interaction.

### BRIEF DESCRIPTION OF THE DRAWINGS

FIG. 1 illustrates a gaming console that delivers alternate content during video game wait times, according to an embodiment of the present disclosure.

FIG. 2 illustrates an example of a gaming console that retrieves alternate content from an external source, according to an embodiment of the present disclosure.

FIG. 3 illustrates an example of a gaming console that stores or generates alternate content, according to an embodiment of the present disclosure.

FIG. 4 illustrates an example of another gaming console that delivers alternate content during video game wait times, according to an embodiment of the present disclosure.

FIG. 5 illustrates an example flow for delivering alternate content during video game wait times, according to an embodiment of the present disclosure.

FIG. 6 illustrates another example flow for delivering alternate content during video game wait times, according to embodiments of the present disclosure.

FIG. 7 illustrates an example of a computer system suitable for implementing techniques of the present disclosure, according to embodiments of the present disclosure.

In the appended figures, similar components and/or features can have the same reference label.

### DESCRIPTION OF ILLUSTRATIVE EMBODIMENTS

Embodiments of the present disclosure are directed to, among other things, controlling delivery of alternate content for a gaming console during game play. In some examples, the delivery of alternate content can be controlled or managed using machine learning models, such as artificial intelligence (AI) models. The gaming console can be operated to provide graphical game images on a screen, such as by operating a video game application. In some examples, game play of the video game application can involve downtime. For example, the graphical game images can present a loading screen while a player map is being loaded, while additional players are being selected to join a queue for an upcoming match, etc. It can be entertaining and engaging for a user for alternate content to be displayed on the screen during this downtime. A machine learning model can determine that an appropriate time (e.g., upcoming downtime) is about to begin. The AI model can estimate a first duration of appropriate time, which can be an estimated duration of the downtime. When the downtime begins, the machine learning model can initiate the providing of alternate content on at least a portion of the screen for a second duration, which can be shorter than the first duration.

To illustrate, consider the following example. A user can interact with a gaming console via an external controller, such as a game console controller, to play a video game application. The gaming console can provide graphical game images for the video game application on a screen. The video game application can be a player-versus-player game in which a group of users can attempt to eliminate other users in the group until only a single user remains. A session of the player-versus-player game might not begin until a sufficient number of users has joined the group. Depending on user availability, some users can experience downtime and can wait in a queue until the sufficient number of users has joined the group. During the downtime, the gaming console can display graphics indicating the downtime, such as a loading screen displaying the number of players that are currently in the queue for the upcoming match or the estimated duration of the downtime.

Depending on the type of game, the graphics requirements involved in loading the map for the upcoming match, the number of players required for the player-versus-player game, game server latency, or other such factors, the downtime can vary. In some examples, the downtime can be up to several minutes long. It can be common for users waiting in the queue to navigate to other applications provided by the video game console, leave the room, or otherwise be inattentive to the screen providing graphical game images. Thus, it can be easy for users to miss the start of the player-versus-player game. Thus, it can be beneficial to increase user attentiveness to the screen during downtime via alternate content displayed on at least a portion of the screen.

The alternate content can in some examples be short-form videos that can be overlaid over an empty portion (e.g., a portion without text, graphics, or other features providing necessary information) of the loading screen. The alternate content can in some examples be accessed from an external source, such as an external content server that hosts video content on a content application. The user interacting with the gaming console can have an account with the content application that is linked to a gaming console account or a video game application account through which the user is playing the video game application. For example, the user can be logged into the linked account for the content application via the gaming console. The alternate content can be accessed from the external content server via the linked account and overlaid over the loading screen, such that the loading screen information (e.g., number of players currently in queue, map loading progress, estimated wait time, etc.) is still visible. The alternate content can be selected and displayed based on its duration.

For example, a machine learning model, such as an AI model, can be trained to predict durations of downtime for loading the player-versus player game in the video game application based on inputs such as number of users currently in the queue, the type of game map that is being loaded, strength of the network connection for the gaming console, hardware specifications for the gaming console, data from the video game application, or any other suitable inputs. In this example, the predicted duration of downtime can be 65 seconds. The AI model can also be trained to determine durations for alternate content to be displayed during the predicted estimated downtime. For example, AI model can determine, based on the predicted downtime of 65 seconds, that two videos with a duration of 30 seconds each can be displayed as alternate content during the downtime while the loading screen is displayed. The total duration of all alternate content can be shorter than the predicted duration of downtime.

Thus, the gaming console can access or generate content with the determined content duration that is less than the predicted duration of downtime. For example, the gaming console can transmit a request to the external content server (e.g., via the linked account for the content application) for two videos each having a duration of 30 seconds. In some examples, the external content server can select the two videos, such as based on user historical interactions with the content application. Additionally or alternatively, the gaming console can request specific videos from the external content server, such as based on historical user interactions with the content application (e.g., via the linked account logged into the gaming console), the video game application, or any other historical user interactions with the gaming console. For example, the selected videos can be videos that the user has previously viewed via the gaming console.

The selected videos can then be displayed by the gaming console on the screen, such as in a picture-in-picture format on the loading screen. The selected videos might not block pertinent information displayed by the loading screen such as number of players in the queue or expected start time. The user can interact with the display of the selected videos, such as via the external controller, to pause, rewind, play, skip, or comment on the selected videos. Playing of the selected videos can conclude before the predicted duration of downtime concludes. In some examples, the AI model can continuously or periodically be executed to continue to predict the duration of downtime. If the predicted duration of downtime changes such that it is now shorter than the remaining playtime of the selected videos, display of the selected videos can in some examples be adjusted. For example, if a first video of two videos, each 30 seconds long, is about to conclude and the AI model generates an updated predicted duration of downtime that is only ten more seconds, the gaming console might not play the second video. Or, in another example, the gaming console can fade out the display of alternate content or display a countdown timer indicating that the display of alternate content is about to cease.

In some examples, the AI model can be used to generate alternate content for the downtime. For example, the AI model can be used to generate videos of previous gameplay (e.g., from recordings of gameplay stored by the gaming console). In another example, the AI model can generate alternate content that is directed to providing information on the upcoming player-versus-player game. For example, during the downtime, the video game application can present a list of players (e.g., identified via usernames) that are being added to the queue for the upcoming player-versus-player game. The gaming console can access player history for the identified players and can use the AI model to generate a report of information regarding the identified players, such as a narration of player tendencies, ranking, result history of previous games, etc.

Embodiments of the present disclosure can provide several advantages over existing video game systems presenting video game content. For example, by presenting alternate content that aligns with a user's interests during downtime of a video game application, the need for a user to navigate to a separate application hosted by a gaming console to fill the downtime can be eliminated. This can reduce the computational demands that can arise from processing commands for quickly switching between executing and presenting content from separate applications. In particular, caching alternate content prior to downtime can allow a gaming console to quickly present cached alternate content with reduced latency in a picture-in-picture format. User experience can also be improved by reducing frustration or distraction caused by lengthy wait times.

In the interest of clarity of explanation, the embodiments can be described in connection with a video game system including a video game console. However, the embodiments are not limited as such and can similarly apply to any other type of a computer system.

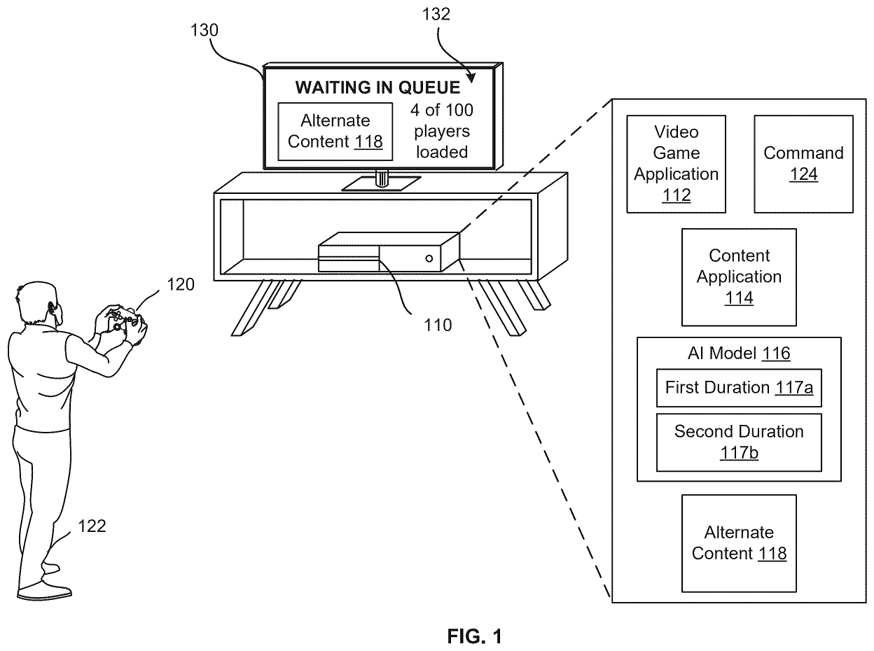

FIG. 1 illustrates a gaming console 110 that delivers alternate content 118 during video game wait times, according to an embodiment of the present disclosure. Gaming console 110 can be communicatively coupled to a video game controller 120 via an input port and a display 130 via an output port. Although not shown, gaming console 110 can also be communicatively coupled to a backend system, such as a set of cloud servers, via a network port. Gaming console 110 can be communicatively coupled with video game controller 120 (e.g., over a wireless network) and with display 130 (e.g., over a communications bus). A video game player 122 can operate video game controller 120 to interact with gaming console 110. These interactions can include playing a video game application 112 that is presented on display 130 or interacting with other applications of gaming console 110 (e.g., with a content application 114 that can stream content (e.g., videos, articles, images, social media feeds, podcasts, audiobooks, email, messages, or any other content from an online content source or to play or otherwise present content from the local storage of gaming console 110).

Gaming console 110 can include a processor and a memory (e.g., a non-transitory computer-readable storage medium) storing computer-readable instructions that can be executed by the processor and that, upon execution by the processor, cause gaming console 110 to perform operations related to various applications. In particular, the computer-readable instructions can correspond to program codes for the various applications of gaming console 110 including video game application 112, content application 114, and in some examples a machine learning model, such as AI model 116. A video game application, such as video game application 112, generally represents a computer application executable to present video game content, receive user interaction with the video game content, and accordingly update the video game content. A content application, such as content application 114, generally represents a computer application executable to present content such as media content including audio, video, and/or other media types, receive user interaction with the content, and accordingly update the content. The content can be streamed from a remote (e.g., external) content source or can be presented from local storage of gaming console 110. Further, other applications can likewise be included in gaming console 110, such as a chat application. The availability of a video game application, content application, and/or other type of computer application to video game player 122 via gaming console 110 can depend on a user identifier of video game player 122 (e.g., upon a login to gaming console 110, the availability of the computer applications can depend on the user identifier used in the login).

Video game controller 120 is an example of an input device. Video game controller 120 can allow video game player 122 to interact with one or more graphical user interfaces (GUIs) presented by gaming console 110 on display 130. For example, using one or more directional control inputs (e.g., a joystick and/or a directional pad), video game player 122 can navigate to and within various menus, dashboards, and UI elements. Other types of input device are possible including a keyboard, a touchscreen, a touchpad, a mouse, an optical system, a microphone, a camera, or other user devices suitable for receiving input of a user. For example, a microphone can allow video game player 122 to interact with the GUIs using various voice commands. As another example, a camera can allow video game player 122 to interact with the GUIs using various gesture commands.

Upon an execution of the video game application 112 by gaming console 110, a rendering process of gaming console 110 can present video game content (e.g., graphical game images) on display 130. The user can then interact with the video game content via video game controller 120. In some examples, the video game content can involve downtime, in which video game player 122 can be unable to interact with the video game content. For example, video game player 122 can select a player map that can require several seconds or minutes to render on display 130. In another example, video game player 122 can join a video game match between multiple (e.g., dozens) of other users. There can be downtime until a full queue of users have joined the video game match. This can be an appropriate time for alternate content 118 to be presented on display 130, as video game application 112 might not display interactive game content on display 130 during the downtime. In the example depicted in FIG. 1, display 130 can instead present a loading screen 132 that indicates that video game player 122 is waiting in a queue and depicts the number of players (e.g., 4 of 100) that are currently loaded in the queue.

For example, gaming console 110 can execute a machine learning model, such as AI model 116, to predict a first duration 117a of the downtime, which can be an appropriate time for alternate content 118 to be presented on display 130. AI model 116 can be hosted locally to gaming console 110. Alternatively, AI model 116 can be hosted remotely to gaming console 110 and can be accessible to gaming console 110 (e.g., via an application-programming interface (API) and/or over a network). It can be possible that AI model 116 can be distributed between gaming console 110 and a remote node. AI model 116 can be a predictive model that can be trained on historical data to generate predictions (e.g., predictions of downtime durations). Examples of AI model 116 can include decision trees, neural networks, time series models, regression models, and the like.

AI model 116 can generate the first duration 117a (e.g., a prediction of the duration of downtime for the video game application 112) based on inputs that can include, but are not limited to, the number of players loaded in the queue, network strength for gaming console 110, hardware or software characteristics of gaming console 110, historical downtime durations for the video game application 112 (e.g., for video game player 122 or multiple video game players), time of gameplay, (e.g., time of day, time of week, time of year, etc.), type of content being loaded in the video game application 112, or any other suitable inputs. In some examples, inputs to AI model 116 can include data crowdsourced from multiple users interacting with the video game application 112 (e.g., using the gaming consoles) or retrieved from the video game application 112. In some examples, inputs to AI model 116 can include an estimated downtime presented by the video game application 112 on display 130. The estimated downtime can be screen-scraped from the display or retrieved from the video game application 112. AI model 116 can be trained on training data that can include historical inputs, as well as associated historical downtime durations that can be used as a ground truth in training AI model 116.

Gaming console 110 can execute AI model 116 to generate the prediction of the first duration 117a in response to determining that video game application 112 is about to display loading screen 132. For example, gaming console 110 can detect that video game player 122 has initiated a match in the video game application 112 (e.g., via video game controller 120) by selecting a “start match” UI element on display 130.

In addition to estimating the first duration 117a, gaming console 110 can execute AI model 116 to determine a second duration 117b during which alternate content 118 is to be presented on display 130. The second duration 117b can be shorter than first duration 117a. For example, a video having the second duration 117b (or multiple videos with a total duration of the second duration 117b) can be retrieved by gaming console 110 and provided on at least a portion of display 130. In some examples, AI model 116 can determine multiple sub-durations of time (with a total duration of the second duration 117b), such as based on historical user interactions of video game player 122 with the video game application 112 and/or the content application(s) 114. For example, if video game player 122 tends to watch short-form content (e.g., less than ten seconds long), AI model 116 can divide the second duration 117b into sub-durations that are approximately ten seconds long.

In some examples, instead of using a machine language model such as AI model 116, a simpler algorithm can be used to find either or both first duration 117a and second duration 117b. For example, wait times or other durations of appropriate time can be averaged across many played games for a particular game title. These averages can then be used to find either or both first duration 117a and second duration 117b. It should be noted that these expected durations can be very different for various game titles, days of the week, times of day, and other factors.

In some examples, a new game can start (or a loading of content in a present game can complete) earlier than an estimated duration of an appropriate time for alternative content 118. In such a case it can be desirable to cease the providing of the alternative content 118 early. In such a situation, information provided to the screen can be monitored. Once an early ending is detected based on screen data, alternative content 118 can be ended immediately or at an appropriate time.

Alternate content 118 can in some examples be content accessed via the content application 114, such as via a linked account for the content application 114. Gaming console 110 can request, from the external content server for the content application 114, content (e.g., videos or groups or sets of videos) with a duration (or combined duration) of the second duration 117b (or, in some examples, multiple videos having the sub-durations that total the second duration 117b). The external content server can return such content to gaming console 110. In other examples, alternate content 118 can be accessed from storage of gaming console 110. For example, gaming console 110 can periodically retrieve and store (e.g., in a cache) content of varying durations from the content application 114. Gaming console 110 can then select content (e.g., videos) of the appropriate length (e.g., matching the second duration 117b or the sub-durations that total the second duration 117b) to be used as alternate content 118 provided on display 130.

Gaming console 110 can overlay alternate content 118 on display 130 as a picture-in-picture, such as on a non-critical portion of the graphical game images (e.g., loading screen 132). The non-critical portion of the graphical game images can be portions of loading screen 132 that do not depict needed information, such as the number of players loaded in the queue or the estimated duration of downtime. In some examples, gaming console 110 can reduce or rearrange some or all components of loading screen 132 to make room for a region of display 130 at which alternate content 118 can be provided. For example, as depicted in FIG. 1, the text “4 of 100 players loaded” can be moved from a center of display 130 to a righthand side of display 130. Alternate content 118 can be displayed on the lefthand side of display 130.

Video game player 122 can interact (e.g., via video game controller 120) with alternate content 118 on display 130 in the same manner as is typical for content provided by the content application 114 on display 130. For example, if alternate content 118 is a video, video game player 122 can pause, play, rewind, fast forward, move to a different portion of the video, comment on the video, or the like by transmitting commands 124 via video game controller 120 to gaming console 110. Gaming console 110 can receive commands 124 via, for example, an input port. Gaming console 110 can then pause (or play, rewind, etc.) alternate content 118 in response to receiving the command 124. If alternate content 118 includes multiple pieces of content, such as multiple videos, video game player 122 can interact with alternate content 118 (e.g., by transmitting commands 124) to skip to the next piece of selected alternate content.

In some examples, AI model 116 can be continually or periodically (e.g., once per second) executed to update the first duration 117a of predicted time left for loading screen 132. If the first duration 117a is reduced by subsequent executions of AI model 116, the second duration 117b might no longer be shorter than the first duration 117a. Thus, alternate content 118 that is being provided based on its second duration 117b might not conclude prior to the downtime concluding (e.g., prior to loading screen 132 switching to display of the match, or other interactive content, in the video game application 112). In such examples, gaming console 110 can cease providing alternate content 118 before the end of the second duration 117b. For example, if alternate content 118 includes multiple videos, gaming console 110 might not display all of the multiple videos to shorten the second duration 117b (e.g., to be shorter than the updated first duration 117a). Or, gaming console 110 can automatically fade out the picture-in-picture display of alternate content 118 shortly before or during transition of loading screen 132 to interactive gameplay. In other examples, display of alternate content 118 can be terminated by video game player 122 (e.g., via video game controller 120).

In some examples, if display of alternate content 118 such as a video was terminated (e.g., due to the downtime concluding) prior to the video concluding, gaming console 110 can store the state of alternate content 118. The state can include the timestamp at which alternate content 118 ceased to be provided at display 130. At a subsequent time when loading screen 132 is presented on display 130, alternate content 118 can resume playing on display 130. For example, alternate content 118 can resume playing at the stored timestamp or shortly before (e.g., ten seconds prior to the stored timestamp) if the remaining duration of alternate content 118 is shorter than the first duration 117a.

In some examples, AI model 116 can be retrained based on the actual duration of downtimes of loading screens for the video game application 112. For example, the actual duration can be used as a ground truth and compared to the predicted first duration 117a generated by AI model 116 to retrain or finetune AI model 116. In some examples, rather than or in addition to executing AI model 116 to control delivery of alternate content 118 on display 130, a rules-based system or model can generate the first duration 117a or the second duration 117b.

In some examples, a reminder or update about the game can be provided as alternate content 118. For example, the alternate content can be a brief update about new players joining the wait for the next game. An update that the game is still waiting for new players or other event can be provide among other alternate content 118. Such an update can quell a players concern that they might have missed the start of a new game. The status can be screen-scraped from information provided by gaming console 110, it can be provided by an external server, or from other source.

Although FIG. 1 illustrates some applications that can be executed on a gaming console 110, the embodiments of the present disclosure are not limited as such. Instead, the applications can be executed on the backend system (e.g., the cloud servers) and/or their execution can be distributed between gaming console 110 and the backend system.

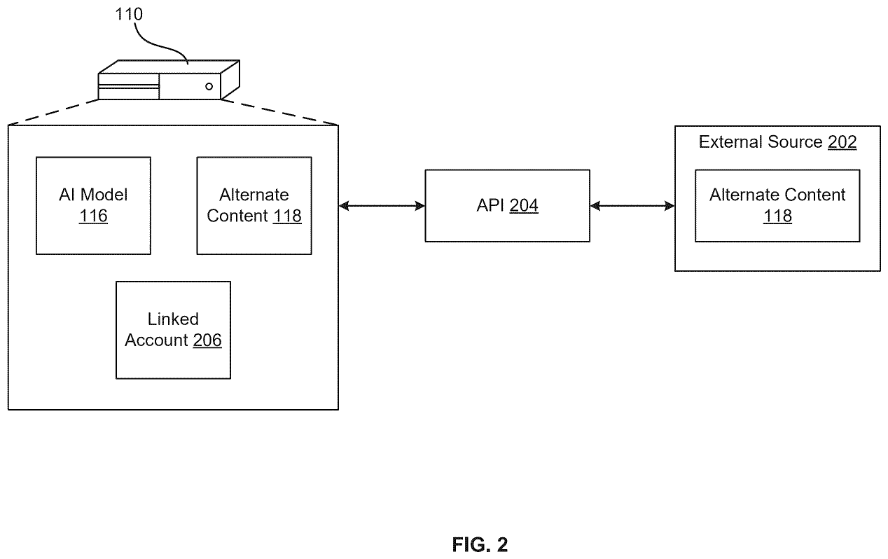

FIG. 2 illustrates an example of a gaming console 110 that retrieves alternate content 118 from an external source 202, according to an embodiment of the present disclosure. Alternate content 118 can be content that differs from content provided by, e.g., the video game application 112 of FIG. 1. External source 202 can be, for example, a media content server, such as a music server, a video server, a social media server, a news server, a messaging server, or the like. External source 202 can be a source that provides alternate content 118.

External source 202 can also provide advertising or other promotional information. The promotional information can be related to the game title being played, the alterative content being provided, the gaming console or other system being used, or other factors.

Gaming console 110 can retrieve alternate content 118 from external source 202 via an application-programming interface (API) 204. For example, gaming console 110 can transmit an API request to the external source 220 via the API 204. The API request can indicate a duration of alternate content 118, such as a 30 second video. In response to the API request, external source 202 can select a piece of content, such as a video, with a duration of 30 seconds. Alternate content 118 can be selected based on historical user interaction with content from external source 202, account settings, user characteristics, etc. In some examples, rather than having external source 202 select alternate content 118, gaming console 110 can select alternate content 118.

For example, a linked account 206 can be associated with external source 202. For example, a user (e.g., video game player 122 of FIG. 1) can login to linked account 206 on gaming console 110. The user can then access content from external source 202 via linked account 206. The user in some examples can opt into sharing personal information, such as historical interaction data, associated with external source 202 with gaming console 110. Gaming console 110 can therefore use the historical interaction data or other personal information available via linked account 206 to select pieces of alternate content 118. Alternate content 118 can in some examples be content that the user has previously watched, saved, bookmarked, interacted with (e.g., commented on), or the like. Or, alternate content 118 can be content that gaming console 110 determines (e.g., via AI model 116) based on the historical interaction data. For example, the selected alternate content 118 can be similar to content previously consumed by the user.

If gaming console 110 selects alternate content 118 that is hosted via external source 202, gaming console 110 can transmit an API request via the API 204 to external source 202. The API request can request the selected alternate content 118. External source 202 can respond to the API request by transmitting alternate content 118 in an API response via the API 204. In some examples, external source 202 can stream alternate content 118 to gaming console 110 (e.g., to be streamed in real time on a screen for gaming console 110). Alternatively, external source 202 can transmit alternate content 118 to gaming console 110, and gaming console 110 can store (e.g., cache) alternate content 118. Gaming console 110 can present alternate content 118 for display (e.g., on a screen) at an appropriate time, such as during downtime of a video game application.

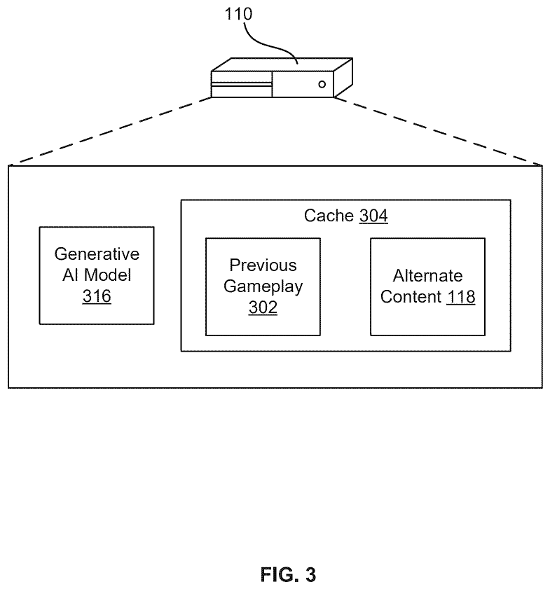

FIG. 3 illustrates an example of a gaming console 110 that stores or generates alternate content 118, according to an embodiment of the present disclosure. For example, gaming console 110 can access alternate content 118 from an external source (e.g., external source 202 of FIG. 2) and can store alternate content 118 in a cache 304. When gaming console 110 determines, during game play (e.g., of a video game application), that an appropriate time for alternate content 118 is about to begin or is beginning, gaming console 110 can provide alternate content 118 (e.g., on a screen) for display. The appropriate time for alternate content 118 can be during a wait time or other downtime of the video game application, during which interactive game play is not possible. Alternate content 118 can be provided onscreen for a second duration that is shorter than a first predicted duration of the appropriate time.

In some examples, gaming console 110 can generate alternate content 118. For example, gaming console 110 can execute a generative AI model 316 to generate alternate content 118. Examples of the generative AI model 316 can include generative adversarial networks (GANs), transformers, diffusion models, variational autoencoders (VAEs), large language models, neural networks, natural language processors, or any suitable generative AI model 316. The generative AI model 316 can be hosted locally to gaming console 110. Alternatively, the generative AI model 316 can be hosted remotely to gaming console 110 and can be accessible to gaming console 110 (e.g., via an application-programming interface (API) and/or over a network). It can be possible that the generative AI model 316 can be distributed between gaming console 110 and a remote node.

Alternate content 118 can in some examples be generated from previous gameplay 302 stored (e.g., in the cache 304) by gaming console 110. For example, the video game application 112 can in some examples store recordings of gameplay for the video game application. The generative AI model 316 can use the stored recordings to generate a video of gameplay highlights. In some examples, the generated video of gameplay highlights can have the second duration 117b determined by AI model 116 of FIGS. 1-2. The generated video can be alternate content 118 that is provided on display 130 during, for example, the first duration 117a of loading screen 132 (e.g., as described in relation to FIGS. 1-2).

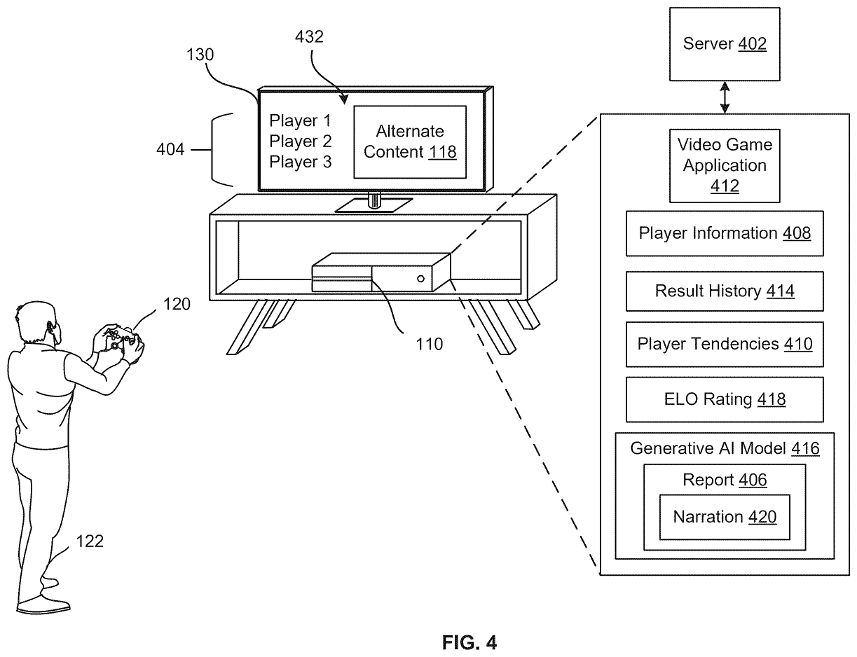

FIG. 4 illustrates an example of another gaming console 110 that delivers alternate content 118 during video game wait times, according to an embodiment of the present disclosure. Gaming console 110 can be communicatively coupled to a video game controller 120 and a display 130. Although not shown, gaming console 110 can also be communicatively coupled to a backend system, such as a set of cloud servers. Gaming console 110 can be communicatively coupled with video game controller 120 (e.g., over a wireless network) and with display 130 (e.g., over a communications bus). A video game player 122 can operate video game controller 120 to interact with gaming console 110. These interactions can include playing a video game application 412 that is presented on display 130. Video game content, such as graphical game images of the video game application 412 can be received by gaming console 110 from a server 402 hosting the video game application 412 and can be provided on display 130.

In some examples, the video game content for the video game application 412 can involve downtime, in which video game player 122 can be unable to interact with the video game content. For example, video game player 122 can select a player map that can require several seconds or minutes to render on display 130. In another example, video game player 122 can join a new game that is a match between multiple (e.g., dozens) of other users. There can be downtime until a full queue of users have joined the new game. This downtime can be an appropriate time for alternate content 118 to be presented on display 130, as the video game application 412 might not display interactive game content on display 130 during the downtime and can instead present a loading screen 432. In the example depicted in FIG. 4, display 130 can present a loading screen 432 that includes informational images indicating a list of players 404 that have joined the queue thus far. It can be beneficial to provide alternate content 118 associated with the list of players 404 on the loading screen 432 during the downtime before the new game. Alternate content 118 can in some examples have a duration that is equal to or less than the second duration 117b generated by AI model 116 of FIGS. 1-2 (e.g., that is shorter than the first duration 117a that is estimated for the downtime).

For example, gaming console 110 can execute a machine learning model, such as generative AI model 416, to generate alternate content 118. Examples of the generative AI model 416 can include generative adversarial networks (GANs), transformers, diffusion models, variational autoencoders (VAEs), large language models, neural networks, natural language processors, or any suitable generative AI model. The generative AI model 416 of FIG. 4 can be a same or different model than the generative AI model 316 of FIG. 3. The generative AI model 416 can generate alternate content 118 based on the list of players 404. The generative AI model 416 can be hosted locally to gaming console 110. Alternatively, the generative AI model 416 can be hosted remotely to gaming console 110 and can be accessible to gaming console 110 (e.g., via an application-programming interface (API) and/or over a network). It can be possible that the generative AI model 416 can be distributed between gaming console 110 and a remote node.

In some examples, the list of players 404 can be retrieved by gaming console 110 from the server 402, which can control the populating of players in the new game of the video game application 412. In other examples, the list of players 404 can only be provided by the server 402 in the form of informational images that visually display the list of players 404. In such examples, gaming console 110 can screen-scrape the graphical images of the list of players 404 provided to display 430. The screen-scraping of the graphical images can be analyzed by gaming console 110 to detect the list of players 404. That is, the text displayed can be converted to actual text and converted into a list of players.

The list of players 404 can in some examples include usernames that identify the players. If a player in the list of players 404 has opted into sharing player history information with gaming console 110, the username and/or the name in the list of players 404 can be used by gaming console 110 to retrieve player information 408 for the associated player. The player information 408 can include, but is not limited to, a result history 314 of previous games, player tendencies 410 in previous games, and an ELO rating 418 of one or more players in the list of players 404. The result history 314 can, for example, indicate a win/loss ratio for previous games. Player tendencies 410 can include types of weapons typically used by the player, regions of a map in which the player tends to be located, types of fighting roles typically selected by the user, play style, or any other player analysis for typical player gameplay. The ELO rating 418 can be a calculation of the relative skill of the player compared to other players of the video game application 412.

The player information 408 can be provided as input to the generative AI model 416, which can use the player information 408 to generate a report 406 on associated players in the list of players 404. The report 406 can summarize the player information 408. The report 406 can be presented, for example on display 430, as alternate content 118 that is provided during the downtime (e.g., while players are being selected for the queue and before the new game is started). The report 406 can include a ranking (e.g., according to the ELO rating 418, the result history 414, or any other means of ranking) of the players in the list of players 404 that have opted to share player information 408.

In some examples, the report 406 can include a narration 420 about the player information 408. The narration 420 can, in some examples, be a natural language output of the generative AI model 416. The narration 420 or other components of the report 406 can be incorporated into alternate content 118 that includes a text image that is generated and presented by gaming console 110 on display 130. Alternate content 118 can, for example, be overlaid on display 130 as a picture-in-picture, such as on a non-critical portion of the loading screen 432. The non-critical portion of the loading screen 432 can be portions that do not depict needed information, such as the list of players 404. In some examples, gaming console 110 can reduce or rearrange some or all components of the loading screen 432 to make room for a region of display 130 at which alternate content 118 can be provided. For example, as depicted in FIG. 4, the list of players 404 can be moved from a center of display 130 to a lefthand side of the display. Alternate content 118 can be displayed on the righthand side of display 130. The narration can be generated to have a length that is some amount of time shorter (for example several seconds) than the appropriate time for the alternative content. Also, text can be provided along with or instead of a narration. The text can be provided as alternate content. The amount of text can be reflective of the expected duration of the appropriate time for the alternative content.

Additionally or alternatively, the narration 420 (or other components of the report 406) can be provided to video game player 122 via audio that can be output by speakers or other audio devices that are communicatively coupled to gaming console 110. For example, the generative AI model 416 can be a voice generator that can generate a text-to-speech audio for the narration 420.

In some examples, one of the inputs to generative AI model 416 that is used in generate the report 406 can include the first duration 117a that is an estimated prediction of the duration of downtime and/or the second duration 117b (e.g., as generated by AI model 116 of FIGS. 1-2). The generative AI model 416 can thus generate the narration 420 to have an audio duration that is less than the first duration 117a (or, in some examples, the second duration 117b). This can ensure that output of the narration 420 can conclude prior to the new game loading.

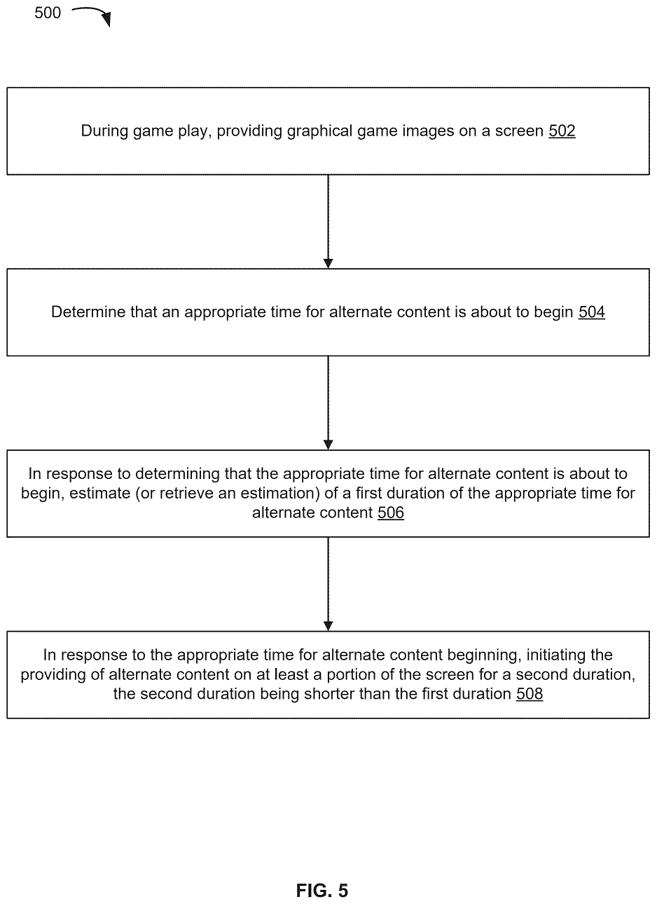

FIG. 5 illustrates an example flow 500 for delivering alternate content during video game wait times, according to an embodiment of the present disclosure. The operations of flow 500 can be implemented as hardware circuitry and/or stored as computer-readable instructions on a non-transitory computer-readable medium of a computer system, such as any of the computer systems described herein (e.g., a user device and/or a server). As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is necessary and that one or more operations can be omitted, skipped, and/or reordered.

In an example, flow 500 includes operation 502, where the computer system operates a gaming console to, during game play, provide graphical game images on a screen. The graphical game images can be provided to the screen via a display output port of the gaming console. The graphical game images can be associated with a video game application. A user can interact with the video game application via an external controller. The gaming console can include an input port that can receive signals from the external controller, such as via a network. The signals can be used to update the graphical game images.

In an example, flow 500 includes operation 504, where the computer system operates the gaming console to determine that an appropriate time for alternate content is about to begin. The appropriate time can be, in some examples, a period of downtime for the video game application in which the video game application might not display or provide interactive game content. An example of the downtime can be during a loading or wait time in which the video game application and/or the gaming console is loading elements of the video game application, such as a new game that involves several other users. The downtime can be a few (e.g., five) seconds or up to several minutes long, such as up to five, ten, fifteen, etc. minutes long. As a user can be unable to interact with the video game application during the downtime, the user in some examples can send signals via the external controller to navigate to another application hosted by the gaming console. Or, the user can become distracted and can miss the beginning of a new game after the downtime concludes. In some examples, before determining that the appropriate time for alternate content is beginning, the computer system can retrieve alternate content from a source external to the gaming console. For example, the alternate content can be retrieved from a linked account. The alternate content can be stored on the console. The alternate content can in some examples be received via a network interface of the gaming console and stored in a memory of the gaming console.

In an example, flow 500 includes operation 506, where the computer system, in response to determining that the appropriate time for alternate content is about to begin, estimates a first duration of the appropriate time for alternate content. The first duration can in some examples be estimated by an AI model. In some examples, before the appropriate time for alternate content begins, the computer system can estimate the duration of appropriate time for alternate content. In some examples, the duration of appropriate time for alternate content can be estimated by tracking the durations of previous similar appropriate times (e.g., for the same video game application). In these and other embodiments, an estimation that has already been determined can be retrieved and used as the appropriate time.

In an example, flow 500 includes operation 508, where the computer system, in response to the appropriate time for alternate content beginning, initiates the providing of alternate content on at least a portion of the screen for a second duration, the second duration shorter than the first duration. In some examples, the computer system can cease the providing of alternate content at the end of the second duration. The alternate content can be overlayed as a picture-in-picture on a non-critical portion of the graphical game images. In some examples, the graphical game images can be reduced in size to provide a region of the screen where the alternate content is displayed. The estimated duration of the appropriate time can in some examples can be used to determine that the appropriate time for alternate content is about to conclude. If the appropriate time for alternate content is determined to be concluding before the end of the second duration, the computer system can, in response, cease the providing of alternate content before the end of the second duration. In some examples, the computer system can receive a command via the input port to pause the alternate content. In response to receiving the command, the computer system can pause the alternate content.

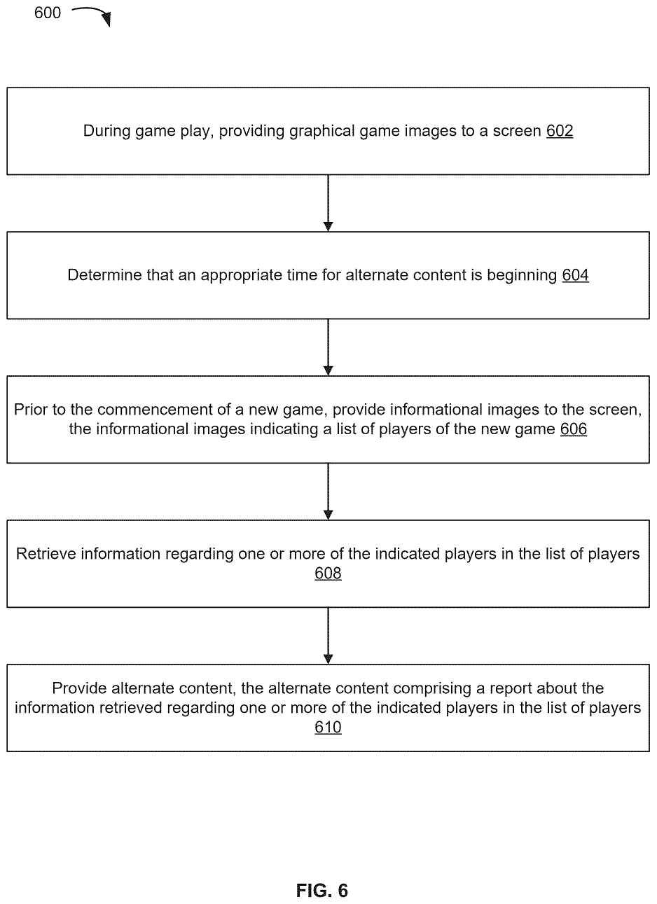

FIG. 6 illustrates another example flow 600 for delivering alternate content during video game wait times, according to embodiments of the present disclosure. The operations of the flow 600 can be implemented as hardware circuitry and/or stored as computer-readable instructions on a non-transitory computer-readable medium of a computer system, such as any of the computer systems described herein (e.g., a user device and/or a server). As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is necessary and that one or more operations can be omitted, skipped, and/or reordered.

In an example, the flow 600 includes operation 602, where the computer system, during game play, provides graphical game images to a screen. The graphical game images can be provided to the screen via a display output port of the gaming console. The graphical game images can be associated with a video game application. A user can interact with the video game application via an external controller. The gaming console can include an input port that can receive signals from the external controller, such as via a network. The signals can be used to update the graphical game images.

In an example, the flow 600 includes operation 604, where the computer system, determines that an appropriate time for alternate content is beginning, wherein the appropriate time comprises a time before a commencement of a new game. In some examples, before the appropriate time for alternate content begins, the computer system can estimate a duration of the appropriate time for alternate content.

In an example, the flow 600 includes operation 606, where the computer system, prior to the commencement of a new game, provides informational images to the screen, the informational images indicating a list of players of the new game. The list of players for the new game can, in some examples, be provided by a server that controls the populating of the new game. In some examples, the list of players for the new game can be generated by screen-scraping the graphical images provided to the screen.

In an example, the flow 600 includes operation 608, where the computer system retrieves information regarding one or more of the indicated players in the list of players. In some examples, the information regarding one or more of the indicated players in the list of players can include tendencies in previous games of one or more players of the new game, a result history of previous games of one or more players of the new game, or an ELO ranking of one or more players of the new game.

In an example, flow 600 includes operation 610, where the computer system provides alternate content, the alternate content comprising a report about the information retrieved regarding one or more of the indicated players in the list of players. The computer system can, in some examples, generate the report based on tendencies in previous games of one or more players of the new game, based on the result history of previous games of one or more players of the new game, or based on an ELO rating of one or more players of the new game. The report in some examples can include a narration and/or text about or containing the information retrieved regarding one or more of the indicated players in the list of players. The narration can be generated using generative artificial intelligence. The narration may, in some examples, end before the commencement of the new game. In some examples, the computer system can generate the alternate content using generative artificial intelligence. The alternate content can have a length that is based on the estimated duration.

In some examples, the computer system can generate text images of the report and can use an output port of the gaming console to provide the text images on the screen. In some examples, the computer system can use the output to overlay the alternate content as a picture-in-picture on a portion of the graphical game images that does not provide needed game information.

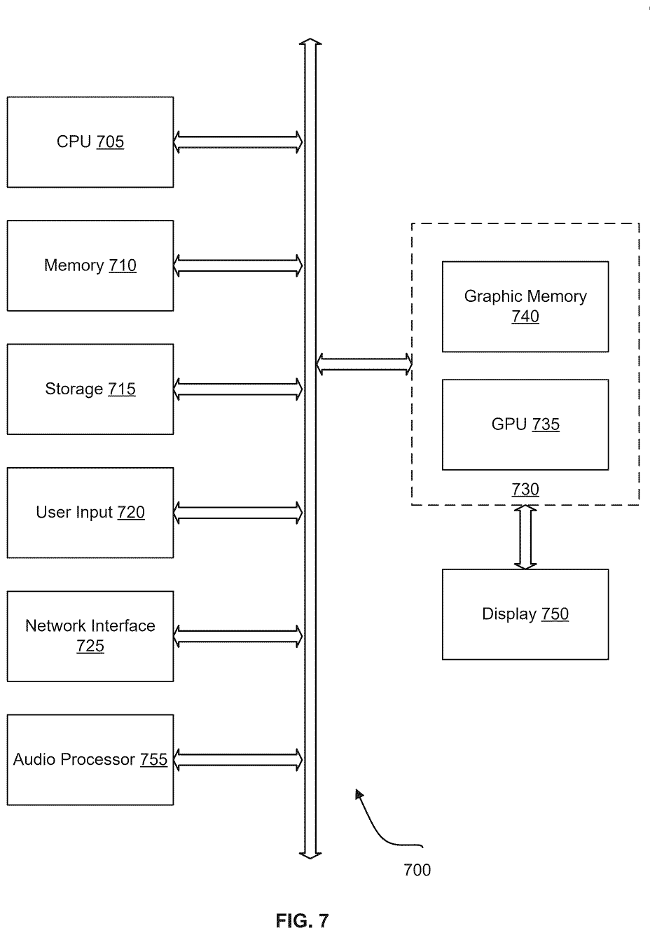

FIG. 7 illustrates an example of a computer system 700 suitable for implementing techniques of the present disclosure, according to embodiments of the present disclosure. The computer system 700 represents, for example, a user device (e.g., a touchscreen device or any other device described herein, above), a video game system, a backend set of servers, or other types of a computer system. The computer system 700 includes a central processing unit (CPU) 705 for running software applications and optionally an operating system. The CPU 705 can be made up of one or more homogeneous or heterogeneous processing cores. Memory 710 stores applications and data for use by the CPU 705 (including possible any of the AI models and any program codes of applications described herein above). Storage 715 provides non-volatile storage and other computer readable media for applications and data and can include fixed disk drives, removable disk drives, flash memory devices, and CD-ROM, DVD-ROM, Blu-ray, HD-DVD, or other optical storage devices, as well as signal transmission and storage media (and can store any of the training data and/or user data described herein above). User input devices 720 communicate user inputs from one or more users to the computer system 700, examples of which can include keyboards, mice, joysticks, touch pads, touch screens, still or video cameras, and/or microphones. Network interface 725 allows the computer system 700 to communicate with other computer systems (including ones hosting any of the AI models described herein) via an electronic communications network and can include wired or wireless communication over local area networks and wide area networks such as the Internet. An audio processor 755 is adapted to generate analog or digital audio output from instructions and/or data provided by the CPU 705, memory 710, and/or storage 715. The components of computer system 700, including the CPU 705, memory 710, data storage 715, user input devices 720, network interface 725, and audio processor 755 are connected via one or more data buses 760.

A graphics subsystem 730 is further connected with the data bus 760 and the components of the computer system 700. The graphics subsystem 730 includes a graphics processing unit (GPU) 735 and graphics memory 740. The graphics memory 740 includes a display memory (e.g., a frame buffer) used for storing pixel data for each pixel of an output image. The graphics memory 740 can be integrated in the same device as the GPU 735, connected as a separate device with the GPU 735, and/or implemented within the memory 710. Pixel data can be provided to the graphics memory 740 directly from the CPU 705. Alternatively, the CPU 705 provides the GPU 735 with data and/or instructions defining the desired output images, from which the GPU 735 generates the pixel data of one or more output images. The data and/or instructions defining the desired output images can be stored in the memory 710 and/or graphics memory 740. In an embodiment, the GPU 735 includes 3D rendering capabilities for generating pixel data for output images from instructions and data defining the geometry, lighting, shading, texturing, motion, and/or camera parameters for a scene. The GPU 735 can further include one or more programmable execution units capable of executing shader programs.

The graphics subsystem 730 periodically outputs pixel data for an image from the graphics memory 740 to be displayed on the display device 750. The display device 750 can be any device capable of displaying visual information in response to a signal from the computer system 700, including CRT, LCD, plasma, and OLED displays. The computer system 700 can provide the display device 750 with an analog or digital signal.

In accordance with various embodiments, the CPU 705 is one or more general-purpose microprocessors having one or more processing cores. Further embodiments can be implemented using one or more CPUs 705 with microprocessor architectures specifically adapted for highly parallel and computationally intensive applications, such as media and interactive entertainment applications.

The components of a system can be connected via a network, which can be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network can include both wired and wireless connections, including optical links. Many other examples are possible and apparent to those skilled in the art in light of this disclosure. In the discussion herein, a network can or can not be noted specifically.

Computer programs incorporating features of the present invention that can be implemented using program code can be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.). Computer readable media encoded with the program code can include an internal storage medium of a compatible electronic device and/or external storage media readable by the electronic device that can execute the code. In some instances, program code can be supplied to the electronic device via Internet download or other transmission paths.

In the foregoing specification, the invention is described with reference to specific embodiments thereof, but those skilled in the art will recognize that the invention is not limited thereto. Various features and aspects of the above-described invention can be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments can omit, substitute, or add various procedures or components as appropriate. For instance, it should be appreciated that, in alternative embodiments, the methods can be performed in an order different from that described, and that various steps can be added, omitted, or combined. Also, features described with respect to certain embodiments can be combined in various other embodiments. Different aspects and elements of the embodiments can be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments can be practiced without these specific details. For example, well-known circuits, processes, algorithms, structures, and techniques have been shown without unnecessary detail in order to avoid obscuring the embodiments.

Also, it is noted that the embodiments can be described as a process which is depicted as a flow diagram or block diagram. Although each can describe the operations as a sequential process, many of the operations can be performed in parallel or concurrently. In addition, the order of the operations can be rearranged. A process can have additional steps not included in the figure.

Moreover, as disclosed herein, the term “memory” or “memory unit” can represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments can be implemented by hardware, software, firmware, middleware, microcode, hardware description languages, or any combination thereof. When implemented in software, firmware, middleware, or microcode, the program code or code segments to perform the necessary tasks can be stored in a computer-readable medium such as a storage medium. Processors can perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 76%, 135%, 90%, 100%, 105%, 109%, 109.9% or, depending on the context within which the term substantially appears, value otherwise as known in the art.

Having described several embodiments, it will be recognized by those of skill in the art that various modifications, alternative constructions, and equivalents can be used without departing from the spirit of the invention. For example, the above elements can merely be a component of a larger system, wherein other rules can take precedence over or otherwise modify the application of the invention. Also, a number of steps can be undertaken before, during, or after the above elements are considered. Accordingly, the above description should not be taken as limiting the scope of the invention.

What is claimed is:

1. A method of operating a gaming console, the method comprising, by the gaming console:
during game play, providing graphical game images to a screen;
determining that an appropriate time for alternate content is beginning, wherein the appropriate time comprises a time before a commencement of a new game;
prior to the commencement of a new game, providing informational images to the screen, the informational images indicating a list of players of the new game;
retrieving information regarding one or more of the indicated players in the list of players; and
providing alternate content, the alternate content comprising a report about the information retrieved regarding one or more of the indicated players in the list of players.

2. The method of claim 1, wherein the report comprises a narration about the information retrieved regarding one or more of the indicated players in the list of players, wherein the narration is generated using generative artificial intelligence.

3. The method of claim 2, wherein the narration ends before the commencement of the new game.

4. The method of claim 3, wherein the information regarding one or more of the indicated players in the list of players comprises tendencies in previous games of one or more of the players of the new game.

5. The method of claim 4, wherein information regarding one or more of the indicated players in the list of players comprises a result history of previous games of one or more of the players of the new game.

6. The method of claim 4, wherein the information regarding one or more of the indicated players in the list of players comprises an ELO ranking.

7. The method of claim 4, wherein the list of players for the new game is provided by a server that controls the populating of the new game.

8. The method of claim 4, wherein the list of players for the new game is generated by screen-scraping the graphical images provided to the screen.

9. A gaming console comprising:
an input port to receive signals from an external controller;
a display output port to provide graphical images to a screen;
a memory;
a network interface; and
a processor coupled to the input port, the display output port, the memory, and the network interface, the processor configured to:
during game play, provide graphical game images via the display output port to the screen;
determining that an appropriate time for alternate content is beginning, wherein the appropriate time begins at an end of a game and ends at a commencement of a new game;
prior to the commencement of a new game, providing informational images to the screen using the output port, the informational images indicating players of the new game;
retrieving information regarding one or more of the players of the new game via the network interface; and
providing alternate content to the screen using the output port, the alternate content comprising a report about the information retrieved regarding one or more of the indicated players.

10. The gaming console of claim 9, wherein the processor is further configured to:
before the appropriate time for alternate content begins, estimate a duration of the appropriate time for alternate content and generating the alternate content using generative artificial intelligence, the alternate content having a length based on the estimated duration.

11. The gaming console of claim 10, wherein the processor is further configured to:
generate text images of the report and using the output port to provide the text images on the screen.

12. The gaming console of claim 9, wherein the processor is further configured to:
generate the report based on tendencies in previous games of one or more of the players of the new game.

13. The gaming console of claim 9, wherein the processor is further configured to:
generate the report based on a result history of previous games of one or more of the players of the new game.

14. The gaming console of claim 9, wherein the processor is further configured to:
generate the report based on an ELO rating of one or more of the players of the new game.

15. The gaming console of claim 14, wherein the processor is further configured to:
generate a list of indicated players for the new game by screen-scraping the graphical images provided to the screen.

16. The gaming console of claim 9, wherein the processor is further configured to:
use the output port to overlay the alternate content as a picture-in-picture on a portion of the graphical game images that does not provide needed game information.

17. A computer-readable storage medium having stored therein program code instructions that, when executed by a processor in a computer system, cause the processor to perform a method comprising:
during game play, providing graphical game images via the display output port to the screen;
determining that an appropriate time for alternate content is beginning, wherein the appropriate time comprises a time before a commencement of a new game;
prior to the commencement of a new game, providing informational images to a screen, the informational images comprising a list of identifiers for players of the new game;
retrieving information regarding one or more of the listed players; and
providing alternate content, the alternate content comprising a report about the information retrieved regarding one or more of the indicated players in the list of players.

18. The computer-readable storage medium of claim 17, wherein the report comprises either or both a narration or text containing the information retrieved regarding one or more of the listed players, wherein the report is provided using generative artificial intelligence.

19. The computer-readable storage medium of claim 18, wherein the information regarding one or more of the listed players comprises tendencies in previous games of one or more of the players of the new game.

20. The computer-readable storage medium of claim 18, wherein the information regarding one or more of the listed players comprises an ELO ranking.
